(19) United States
(12) Patent Application Publication
(10) Pub. No.: US 2014/0126489 A1
(43) Pub. Date: May 8, 2014

(54) MANAGING OPERATING PARAMETERS FOR COMMUNICATION BEARERS IN A WIRELESS NETWORK

(71) Applicant: Robert Zakrzewski, Bristol (GB)

(72) Inventor: Robert Zakrzewski, Bristol (GB)

(73) Assignee: INTELLECTUAL VENTURES HOLDINGS 81 LLC, Las Vegas, NV (US)

(21) Appl. No.: 14/005,530

(22) PCT Filed: Mar. 12, 2012
(86) PCT No.: PCT/EP12/54265

§ 371 Date: Nov. 27, 2013

(30) Foreign Application Priority Data
Mar. 18, 2011 (GB) 1104614.1

(51) Int. Cl. H04W 72/12; H04W 74/08

(52) U.S. Cl. CPC H04W 72/1289; H04W 74/0833
USPC 370/329

(57) ABSTRACT

A wireless network having a network device to establish pre-configured shared communication bearers is disclosed. Each pre-configured shared communication bearer may communicate data to a mobile device, via a pre-configured shared radio bearer, using predetermined operating parameters. Each of the pre-configured shared communication bearers may also have a pre-defined quality of service. The predetermined operating parameters needed for the mobile device to communicate via the pre-configured shared radio bearer may be set before the mobile device has information to be communicated.

### FIELD OF INVENTION

The present invention relates to mobile communication networks and methods of transmitting data in mobile communication networks. The present invention also relates to base stations, infrastructure equipment and mobile communications devices.

### BACKGROUND OF THE INVENTION

Wireless mobile telecommunication systems such as the 3GPP defined UMTS and LTE systems have been designed to provide high data rate mobile communication services to users of mobile communication devices. For example, the core network architecture and radio interface of an LTE based mobile telecommunications system is provided with enhanced network infrastructure that enables dedicated high bandwidth communication links to be established between individual mobile communication devices and the network.

Conventionally an LTE network would be expected to provide communication services to mobile devices such as smartphones and personal computers (e.g. laptops, tablets and so on). These types of communication services are typically provided with high performance dedicated data connections optimised for high bandwidth applications such as streaming video data. However, recent developments in the field of machine type communication (MTC) (sometimes referred to as machine to machine (M2M) communication) have resulted in more diverse applications being developed to take advantage of the increasing ubiquity of mobile telecommunication networks. As such it is increasingly likely that an LTE network will also be expected to support communication services for simpler network devices such as smart meters and smart sensors. Devices such as these, generally classified as “MTC devices”, are typically far simpler than conventional LTE mobile communication devices such as smartphones and personal computers and are characterised by the transmission of relatively low quantities of data at relatively infrequent intervals.

Deploying both conventional mobile communication devices such as smart phones along with MTC devices in the same mobile telecommunication network, such as an LTE network, can result in an inefficient use of network and radio resources because there is no means to treat the different types of data differently. For example, the same high performance communication links are established between a communication device and the network irrespective of whether it is a smartphone type communication device about to stream a large quantity of data for a period of several minutes or if it is an MTC device about to transmit a few bytes of data over a few milliseconds. In some examples, the amount of signalling data required to transmit the MTC data may be greater than the total amount of MTC data. In a network in which a large number of MTC devices are deployed along with other devices such as smartphones, a disproportionate amount of network resource may be consumed by MTC devices establishing high performance data connections, only for these connections to be used to transmit trivial amounts of data. This generates additional signalling data which consumes radio resources and also consumes resources in the network as the network is required to perform the processing required to establish the data connections.

Accordingly, providing a mobile telecommunications network which can efficiently support communication devices such as smartphones and personal computers at the same time as well as MTC type devices is a technical problem.

### SUMMARY OF THE INVENTION

In accordance with a first aspect of the present invention there is provided a mobile communications network comprising a core network part and a radio network part. The radio network part includes a plurality of base stations, each of the base stations including a transceiver unit for communicating data to and/or from mobile communications devices via a wireless access interface, and the core network part includes one or more infrastructure equipment which are coupled to the base stations and arranged to communicate the data to and/or from the base stations for communicating to the mobile communications devices. The mobile communications network is arranged in operation to establish one or more pre-configured shared communications bearers between the infrastructure equipment and the base stations. Each of the one or more communications bearers is provided to communicate data to or from one or more of the base stations for at least one of the mobile communications devices in accordance with predetermined operating parameters for providing for each of the one or more pre-configured shared communications bearers a pre-defined quality of service, Each of the one or more pre-configured shared communications bearers is created as a logical connection between the base station and the infrastructure equipment. The mobile communications network is also arranged in operation to establish one or more pre-configured shared radio bearers between the mobile communications device and the one or more base stations for communicating the data to or from the mobile communications device from or to the base stations in accordance with predetermined operating parameters for providing the pre-defined quality of service. The shared radio bearer is allocated the predefined operating parameters which are required for the mobile communications device to communicate via the shared radio bearer before the mobile communications device has data to be communicated via the shared communications bearer.

In accordance with this aspect of the invention, an adapted mobile communications network is provided which allows data to be transmitted to and from mobile communication devices without the need for dedicated communication bearers to be established between the mobile communication devices and the network. Instead, data is transmitted to and from the mobile communication devices via a number of pre-configured communication bearers which in contrast to conventional techniques are configured before the mobile communication devices send or receive any data. Moreover, in accordance with this aspect of the invention, data can be transmitted to and from the mobile communication devices without the mobile communication devices needing to transition from an IDLE state to a CONNECTED state. By adapting the mobile communication devices to use pre-configured bearers and to communicate data without changing to a CONNECTED state, the number of signalling messages that would otherwise be transmitted if operating in accordance with a conventional mobile communication device can be reduced.

In one embodiment of the invention, the mobile communication devices are each allocated a unique identifier by the infrastructure equipment during an initial registration procedure, and the mobile communication devices are arranged to use the unique identifier to transmit uplink data on the one or more pre-configured shared radio bearer.

In accordance with this embodiment, a unique identifier is allocated to each mobile communication device when initially attaching to the network. Conventionally, a mobile communication device must transition to the CONNECTED state to receive a temporary identifier to transmit uplink data. According to this embodiment therefore, a convenient mechanism is provided that allows the mobile communication device to transmit uplink data without needing to transition to the CONNECTED state.

In another embodiment of the invention, the infrastructure equipment is arranged to page the mobile communication devices using a shared radio network temporary identifier to indicate that there is pending downlink data, and in response the mobile communication devices are arranged to monitor a physical control channel on which is transmitted allocation information indicating resources on the shared pre-configured radio bearer on which the downlink data will be transmitted.

In accordance with this embodiment a paging message is sent to the mobile communication device which rather than triggering the mobile communication device to transition to the CONNECTED state to be allocated a dedicated downlink communication bearer, instead triggers the mobile communication device to monitor a physical control channel on which it is indicated which resources of a shared pre-configured radio bearer will be used to transmit downlink data. Accordingly, downlink data can be received by the mobile communication device without needing to transition to the CONNECTED state.

Various further features and aspects of the invention are defined in the claims and include base stations, infrastructure equipment and mobile communications devices.

### BRIEF DESCRIPTION OF DRAWINGS

Embodiments of the present invention will now be described by way of example only with reference to the accompanying drawings where like parts are provided with corresponding reference numerals and in which:

FIG. 1a provides an example of a conventional Public Land Mobile Network (PLMN) arranged in accordance with 3GPP defined Long Term Evolution architecture;

FIG. 1b provides a diagram illustrating the different states occupied by mobile communication device operating in accordance with LTE;

FIG. 2 provides a schematic diagram illustrating an arrangement of communication bearers for uplink data transmission in accordance with an example of the present invention;

FIG. 3 provides a schematic diagram illustrating an arrangement of communication bearers for downlink data transmission in accordance with an example of the present invention;

FIG. 4 provides a schematic diagram illustrating an attach procedure in accordance with an example of the present invention;

FIG. 5 provides a schematic diagram illustrating a random access message procedure adapted in accordance with an example of the present invention;

FIG. 6 provides a schematic diagram illustrating an uplink data transmission procedure in accordance with an example of the present invention;

FIG. 7 provides a schematic diagram illustrating a first downlink data transmission procedure in accordance with an example of the present invention;

FIG. 8 provides a schematic diagram illustrating an alternative downlink data transmission procedure in accordance with an example of the present invention;

FIG. 9 provides a schematic diagram illustrating a network arrangement for determining if downlink data should be communicated conventionally or using a shared bearer technique, and

FIG. 10 provides a schematic diagram showing an uplink protocol stack of a mobile communication device for determining if uplink data should be communicated conventionally or using a shared bearer technique.

### DETAILED DESCRIPTION OF EXAMPLE EMBODIMENTS

### LTE PLMN

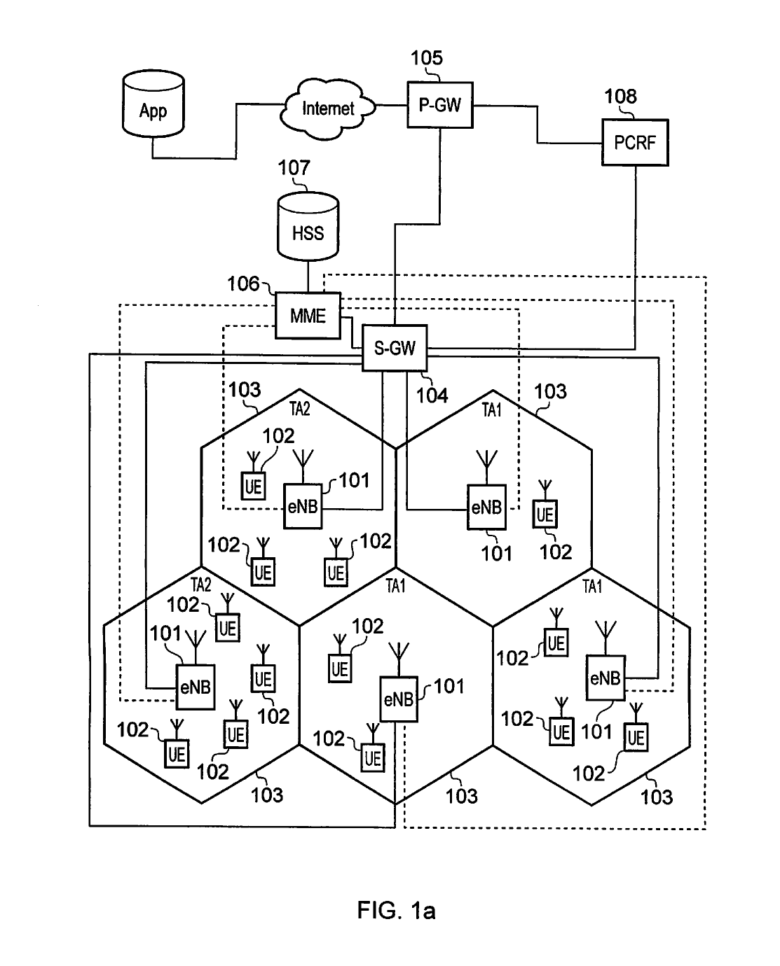

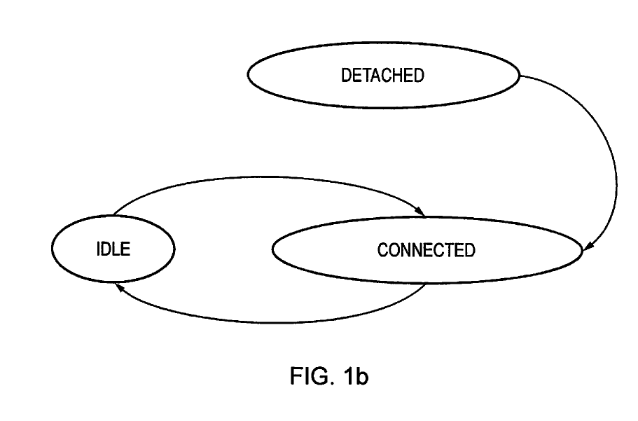

FIG. 1a provides an example of a conventional Public Land Mobile Network (PLMN) arranged in accordance with 3GPP defined Long Term Evolution architecture. The mobile network includes a plurality of base stations known in the art as enhanced Node-Bs 101 (eNBs) each of which include a transceiver unit enabling communication of data to and from a plurality of mobile communication devices (e.g. mobile communication devices) via a radio interface. Each mobile communication device includes a transceiver for communicating data to and from the eNBs and a USIM which uniquely identifies the mobile communication device.

Each eNB 101 provides a coverage area 103 (i.e. a cell) and communicates data to and from the mobile communication devices 102 within the coverage area/cell 103. Each eNB 101 is connected to a Serving Gateway (S-GW) 104 which routes user data to and from the eNBs 101 and supports mobility when mobile communication devices 102 handover between eNBs 101 as is known in the art.

The mobile network is typically divided into a number of tracking areas TA1, TA2 each of which comprise a number of eNBs 103. Together the tracking areas form a network coverage area providing access to the PLMN over a geographic area. The S-GW 104 is connected to a Packet Data Network Gateway 105 (P-GW) which is the network entity from which packet data is routed into and routed out of the network. The mobile telecommunication network also includes a Mobility Management Entity 106 (MME) connected to the S-GW 104 and the eNBs 101. The MME 106 is responsible for authenticating mobile communication devices 102 attempting to access the network by retrieving subscriber profile information stored in a Home Subscriber Server 107 (HSS). The MME 106 also tracks the location of each mobile communication device 102 that has joined the network. A Policy and Charging Resource Function 108 (PCRF) is connected to the P-GW 105 and the S-GW 104. The PCRF 108 controls access policy such as quality of service afforded to various data transmissions. The PCRF also manages charging functions via interactions with the P-GW 105 and the S-GW 104. The eNBs grouped together form a radio network part of the PLMN and the infrastructure equipment of the PLMN, namely the S-GW, MME and P-GW form a core network part of the PLMN.

### Conventional Mobile Communication Device States and Network Registration

A mobile communication device when powered on is typically in one of three states: DETACHED, IDLE or CONNECTED. This is illustrated in FIG. 1b. An LTE mobile communication device typically is initially in the DETACHED state, transitions to the CONNECTED state and then transitions between the CONNECTED state and the IDLE state. This process is explained in more detail below. In the DETACHED state, the mobile communication device 102 is usually either in the process of attempting to attach to the network or out of range of the network coverage area. In the IDLE state, the mobile communication device 102 has been authenticated and has attached to the network but typically is not transmitting or receiving any data packets. When in the IDLE state, the tracking area from which the mobile communication device 102 last communicated to the network is stored in the MME 106. Typically, no further information about the identity of the mobile communication device 102 is stored in any of the eNBs or the S-GW. When in the CONNECTED state, the coverage area/cell 103 in which the mobile communication device 102 is located is known by the network so that data packets can be routed to and from the mobile communication device 102. The mobile communication device 102 also has a radio resource connection with the eNB 101 so that dedicated uplink and downlink radio resources can be specifically assigned to the mobile communication device.

When a mobile communication device 102 is first switched on the following registration procedure is typically followed:
1. mobile communication device switched on.
2. The mobile communication device scans all relevant frequencies to detect if it is within a coverage area of an available PLMN.
3. If a PLMN is available which the USIM of the mobile communication device indicates is a permitted PLMN, the mobile communication device camps onto the detected PLMN and sends an attach request in the form of a non-access stratum (NAS) message.
4. The mobility management entity (MIME) authenticates the mobile communication device and a S1 communication bearer is established between the eNB and the S-GW and a default communication S5/S8 bearer is established between the S-GW and the P-GW (the S1 bearer and the S5/S8 bearer are described further below).
5. An attach accept message is sent from the MME to the mobile communication device and the mobile communication device moves to the CONNECTED state. After a predetermined period of inactivity the mobile communication device moves to the IDLE state and the S1 bearer is taken down.

### Conventional LTE Communication Bearers

In mobile telecommunications systems such as LTE, a packet data network (PDN) connection is provided to the mobile communication device by virtue of a number of logical connections known as a communication bearers. For example, in LTE there are two types of communication bearers, namely default bearers and dedicated bearers. A default bearer is established whenever a mobile communication device registers with the network. The default bearer typically has a “best effort” quality of service (QoS) associated with it and is therefore used for the transmission of data for which QoS is of lower importance. On the other hand, dedicated bearers are established on demand (either by the user of the network) and can provide specific (QoS) levels.

Each communication bearer in LTE comprises three components, namely a radio bearer established between the mobile communication device and the eNB, an S1 bearer established between the eNB and S-GW and an S5/S8 bearer established between the S-GW and the P-GW. Data is transported via the S1 bearers and the S5/S8 bearers using the GPRS tunnelling protocol (GTP) in which each data packet is appended with a tunnel endpoint identifier (TEID) which identifies the nodes at the end of each bearer (i.e. a particular tunnel end-point is associated with a particular mobile communication device). In conventional LTE systems there is a one-to-one mapping between the radio bearer, S1 bearer and S5/S8 bearer. In other words, each radio bearer is associated with a single S1 bearer which is associated with a single S5/S8 bearer.

Each dedicated bearer (comprising a radio bearer, S1 bearer and S5/S8 bearer) is associated with a number of QoS parameters which are provided to each packet being transported via that bearer. These QoS parameters include factors such as scheduling priority, guaranteed minimum bit-rate, maximum bit-rate, packet delay budget and so on. The QoS parameters are held in a traffic flow template (TFT) which is typically stored at the mobile communication device and the P-GW. The TFT also contains information regarding all the relevant TEIDs associated with the bearer. Before a dedicated bearer can be established, the QoS parameters specified in the TFT are authorised by the network after a request from the mobile communication device (or an application running on the mobile communication device).

In conventional LTE systems, if there are pending uplink data packets to be transmitted from the mobile communication device or the network has paged the mobile communication device indicating there are pending downlink data packets to be received, the mobile communication device must transition from the IDLE state to the CONNECTED state. When this happens a dedicated bearer (comprising a radio bearer, S1 bearer and S5/S8 bearer) must be established. This consumes radio and network resources as the bearer QoS must be configured as described above. Furthermore, radio resources are consumed as random access and/or paging messages are transmitted over the radio interface. As will be understood, a mobile communication device running an application that infrequently transmits small quantities of data will not use the available network resources in a particularly efficient manner as a relatively high amount of network resource is consumed establishing a dedicated bearer, only for a small quantity of data to be transmitted. This problem may be compounded if a mobile network includes a great many such mobile communication devices resulting in frequent requests for dedicated bearers for the transmission of low volumes of data. The overall effect can be to greatly reduce network efficiency degrading the QoS available for other users.

### Pre-Configured Bearers

In the following examples of the present technique, a number of adaptations to conventional mobile telecommunication infrastructure elements and data transmission procedures are provided that allow small quantities of data to be transmitted on a frequent basis with a reduced impact on network efficiency. As will become clear this is achieved by providing a number of pre-configured communication bearers which are shared between multiple mobile communication devices. In some embodiments the network is arranged to distinguish between small packets of data suitable to be transmitted according to examples of the present technique and regular data which need not be transmitted according to these techniques. In the following examples data transmitted to the mobile communication device in accordance with the present technique is generally referred to as “downlink small packet data” and data transmitted from the mobile communication device in accordance with the present technique data is generally referred to as “uplink small packet data”.

In one example the mobile communication devices are configured as MTC devices. MTC devices are usually autonomous or semi-autonomous devices that are configured to transmit and receive small quantities of data. Examples of MTC devices include so-called smart meters which periodically transmit data via the PLMN reporting the consumption of gas, electricity, water and so on to a remote server. An MTC device typically transmits small quantities of data at infrequent but regular intervals.

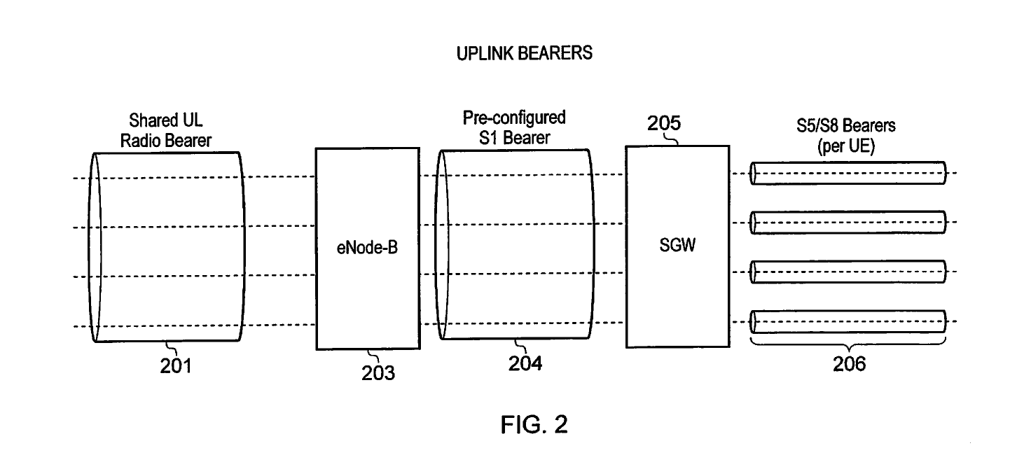

FIG. 2 provides a schematic diagram illustrating an arrangement of communication bearers for uplink data transmission that enable data to be communicated from a mobile communication device without the mobile communication device needing to transition to the CONNECTED state and without the need for the network to undertake conventional bearer configuration procedures thereby increasing network efficiency. A shared uplink radio bearer 201 is provided via which uplink small packet data can be transmitted from mobile communication devices within a cell. The QoS parameters of the shared uplink radio bearer 201 are pre-established and stored in each of the mobile communication devices and the eNB. In some examples QoS parameters are stored in memory on each mobile communication device. In some examples the QoS parameters are signalled via NAS signalling during the attach procedure or may be pre-configured by device configuration means. In other examples this information is signalled to the mobile communication devices on the BCCH of the cell.

In order to access the shared uplink radio bearer 201, on registration with the network each mobile communication device is allocated a UE shared channel identifier (UESCID) which is included in uplink small packet data transmitted by the mobile communication devices on the shared uplink radio bearer 201. The UESCID allocated to each mobile communication device is unique within the geographical area controlled by the UESCID allocating entity. Unlike a conventional radio bearer, any suitably adapted mobile communication device can transmit data on the shared uplink radio bearer 201.

When uplink small packet data transmitted from a mobile communication device on the shared uplink radio bearer 201 is received, the eNB 203 identifies the UESCID and forwards the data via a pre-configured uplink S1 bearer 204 to the S-GW 205.

The pre-configured uplink S1 bearer 204 is typically established at network start-up. In other words, before any uplink data is received an S1 bearer context is defined which specifies the operating parameters of the S1 bearer such as QoS (including transport QoS parameters such as Diffsery code points), TEIDs, and so on.

In some examples the system can be arranged such that the pre-configured uplink S1 bearer is used exclusively for data transmitted from the shared uplink radio bearer 201. The pre-configured S1 bearer therefore differs from conventional S1 bearers in that it is established before any mobile communication device attempts to send uplink data and in that it is shared by multiple mobile communication devices.

Upon receipt of uplink small packet data on the pre-configured uplink S1 bearer 204, the S-GW 205 maps the uplink small packet data onto uplink S5/S8 bearers 206 (typically arranged on a per mobile communication device basis) for forwarding onto the destination of the data. Typically the MME signals to the S-GW 205 the UESCID allocated to the mobile communication device for accessing the shared bearer. The UESCID is carried in data sent over the shared S1 bearer. Based on this UESCID, the S-GW 205 can detect data coming from a particular mobile communication device despite the fact that the uplink data is sent over a shared S1 bearer 204.

As will be explained below, in some examples the S5/S8 bearers are configured when a mobile communication device first registers with the network. In some examples the mobile communication device will request a specific access point name (APN) be used. Alternatively the system may use default parameters specifying a particular APN or P-GW. The APN (and in some scenarios also the P-GW) can be used exclusively for small packet transmission or be shared with the APN (and in some scenarios P-GW) used for conventional uni-cast communication. The following options are possible for the pre-configured S5/S8 bearers:
the pre-configured S5/S8 bearers are used only for small packet data transmission
two pre-configured S5/S8 bearers are specified, one for small packet data transmission and one for unicast transmission
the pre-configured S5/S8 bearers are common for all types of communication

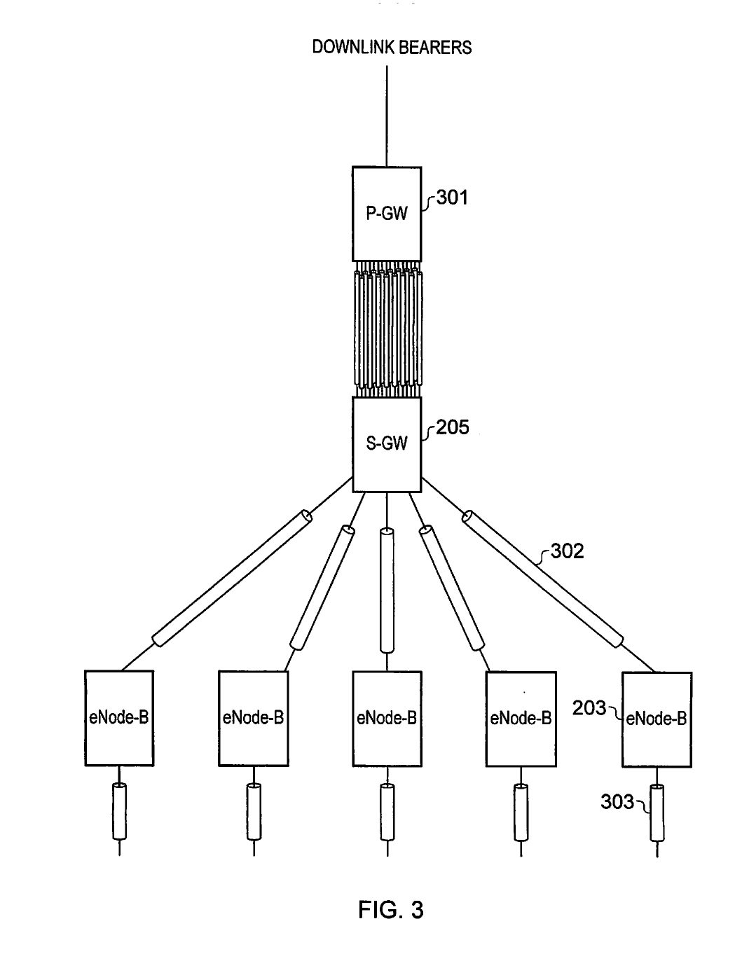

FIG. 3 provides a schematic diagram illustrating an arrangement of communication bearers for downlink data transmission that enable downlink small packet data to be communicated from a mobile communication device without the mobile communication device transitioning to the CONNECTED state. When downlink small packet data is received from an external source at the P-GW, it is forwarded to the S-GW 205 using S5/S8 downlink bearers in a conventional fashion. Upon receipt of the downlink small packet data, the S-GW 205 forwards it to one or more of the eNBs on a pre-configured downlink S1 bearer 302. The pre-configured downlink S1 bearer 302 is pre-configured in a similar way to the pre-configured uplink S1 bearer 204. The S-GW 205 attaches the UESCID allocated at registration time to the downlink small packet data and forwards it on the pre-configured downlink S1 bearer to the recipient eNB. The recipient eNB (or eNBs) then transmit the downlink small packet data to all mobile communication devices within its cell on a shared downlink radio bearer 303. The shared downlink radio bearer 303 is pre-configured in a similar way to the shared uplink radio bearer 201 in that the QoS parameters of the shared uplink radio bearer 201 are pre-established and stored in each of the mobile communication devices and the eNB. As will be explained in more detail below, downlink small packet data is transmitted on the shared downlink radio bearer 303 using a specially defined small packet radio network temporary identifier (SP-RNTI). The downlink small packet data is received by all mobile communication devices in each cell in which the data is transmitted. The operation of an adapted LTE mobile telecommunication system in which the shared and pre-configured bearers shown in FIGS. 2 and 3 are deployed will now be described with reference to a mobile communication device registration procedure, a random access procedure, uplink and downlink data transmission procedures and security and mobility procedures.

### Mobile Communication Device Registration Procedure

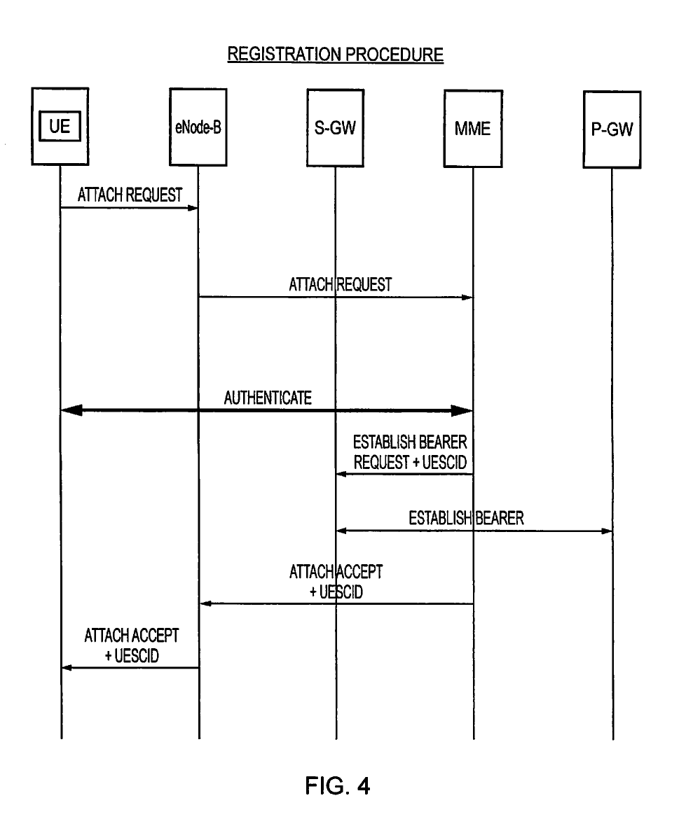

FIG. 4 provides a schematic diagram illustrating an attach procedure in accordance with examples of the present invention.

As shown in FIG. 4, first the mobile communication device scans all relevant frequencies to detect if it is within a coverage area of an available PLMN and if available camps onto the detected PLMN. An attach request is then sent from the mobile communication device in the form of a NAS message. This is forwarded to the MME which authenticates the mobile communication device. The MME sends a message to the S-GW requesting that a S5/S8 bearer is established between the S-GW and P-GW. An adapted attach accept message is sent from the MME via the eNB to the mobile communication device. The adapted attach accept message includes a mobile communication device shared channel identifier (UESCID). The UESCID is generated by the MME and uniquely identifies each mobile communication device in the geographical area served by the MME. Assuming no further network activity occurs, after a certain period of time the mobile communication device transitions to the IDLE state in the conventional way and the mobile communication device location is tracked in the conventional way i.e. the tracking area within which the mobile communication device is tracked.

### Random Access Procedure

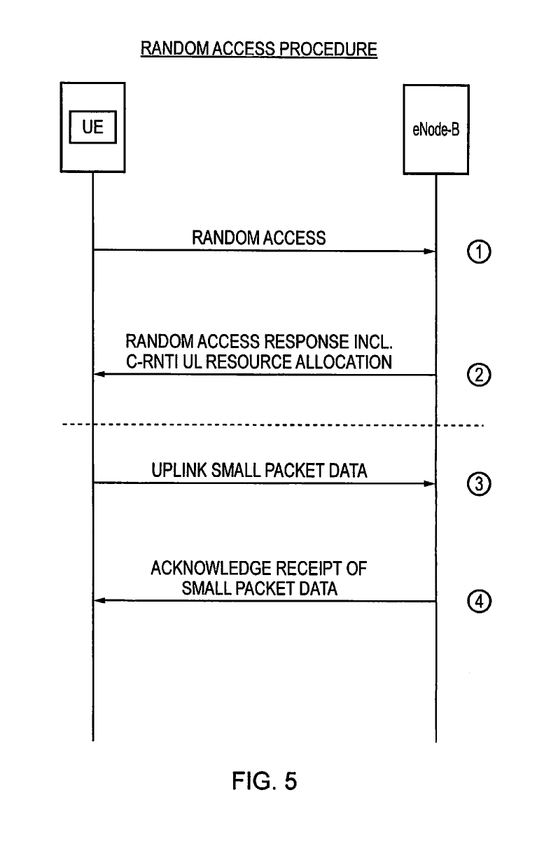

Before a mobile communication device can transmit uplink data, a random access must be made to the network. FIG. 5 provides a schematic diagram illustrating a random access message procedure adapted in accordance with examples of the present technique.

As shown in FIG. 5, first the mobile communication device transmits a random access request message (message 1) on the Random Access Channel (RACH). The C-RNTI is used as a temporary mobile communication device identifier used to allocate resources for UL transmission and is assigned in the same way as for other “unicast” users which do not use the shared uplink radio bearer.

The eNB responds to the random access request message by transmitting a random access response message (message 2) which includes a temporary Cell Radio Network Temporary Identifier (C-RNTI) and an indication of an allocation of uplink radio resources. The uplink radio resource indication indicates which LTE physical resource blocks (PRBs) have been allocated on the physical uplink shared channel (PUSCH). In some examples the random access procedure terminates here.

In other examples, the mobile communication device transmits a third message (message 3). Conventionally, message 3 of the random access procedure contains a Layer 2/Layer 3 message. However, in accordance with examples of the present technique, if the quantity of uplink small packet data is sufficiently small (for example a few bytes) message 3 of the random access procedure itself can be used to transmit the uplink small packet data along with the UESCID. The eNB then transmits a final message (message 4) which is used to acknowledge that the small packet data sent in message 3 has been received. The random access procedure then terminates.

If the UESCID is transmitted in message 3, the eNB determines that that random access request relates to communication of small packet data.

### Uplink Data Transmission Procedure

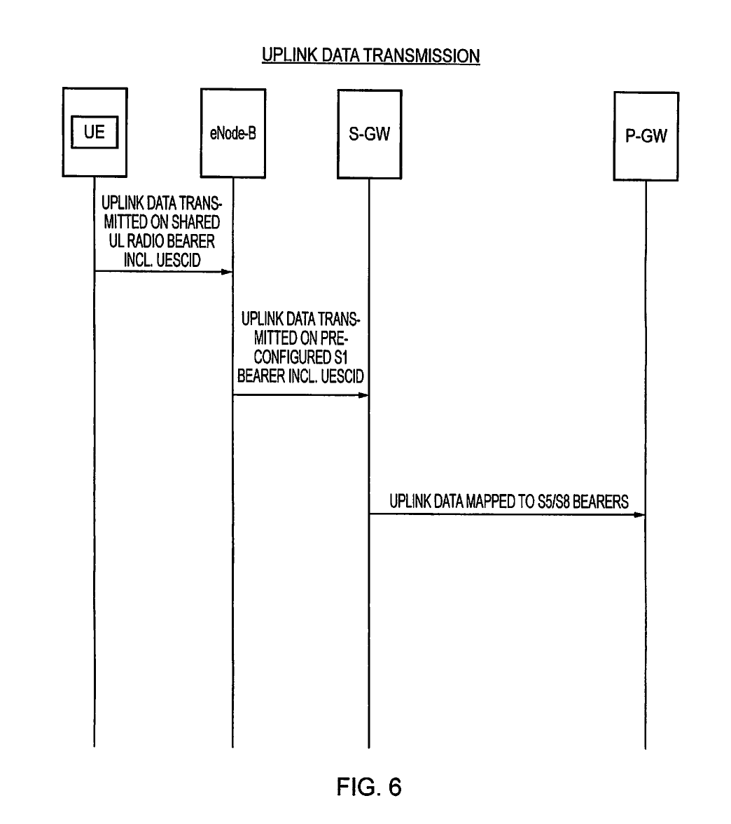

In the case where the random access procedure terminates at message 4 and/or where there is additional uplink small packet data to be transmitted which is too large to be transmitted in message 3 of the random access procedure, the mobile communication device transmits uplink small packet data on the shared uplink radio bearer using the C-RNTI signalled in message 2 of the random access procedure. The mobile communication device includes its UESCID in this data. This is illustrated in FIG. 6.

As shown in FIG. 6, when the eNB receives the uplink small packet data (either transmitted on the shared uplink radio bearer or received in message 3 of the random access procedure), the eNB recognises that it is uplink small packet data by identifying the UESCID and forwards the uplink small packet data to the S-GW on the pre-configured S1 bearer.

Upon receipt of the message from the eNB, the S-GW references a mapping table which maps UESCIDs to specific S5/S8 bearers which are configured on a per mobile communication device basis and provide means for forwarding the uplink small packet data from the mobile communication device to the P-GW where it is routed onwards as however required.

During the transmission of the small packet data, typically the mobile communication device does not transition to the CONNECTED state therefore there is never an explicit release of the C-RNTI allocated to the mobile communication device in message 2 of the random access procedure. Therefore in some examples, the C-RNTI can be implicitly released after the mobile communication device was allocated resources to send uplink data (e.g. after one allocation). In another example the C-RNTI is released after a pre-defined time signalled on the BCCH or the mobile communication device signals a null bandwidth (BW) request. The BW requests can also be “piggybacked” on to an uplink message or sent via the RACH which is similar to conventional techniques.

### Downlink Data Transmission Procedure

In conventional LTE downlink data transmission, downlink data is transmitted to a mobile communication device via a dedicated bearer using resources specifically allocated to that mobile communication device. However, in accordance with the examples of the present invention downlink data is transmitted from the eNB to the mobile communication device using a shared downlink radio bearer which is established between the eNB and every suitably configured mobile communication device in the cell. Before the downlink small packet data can be transmitted, the mobile communication devices need to be informed a) that there is pending downlink small packet data and b) on which PRBs of the physical downlink shared channel (PDSCH) downlink small packet data from the shared downlink radio bearer is transmitted. Two examples of how this can be achieved are explained below:

### Shared Downlink Bearer

### Example 1

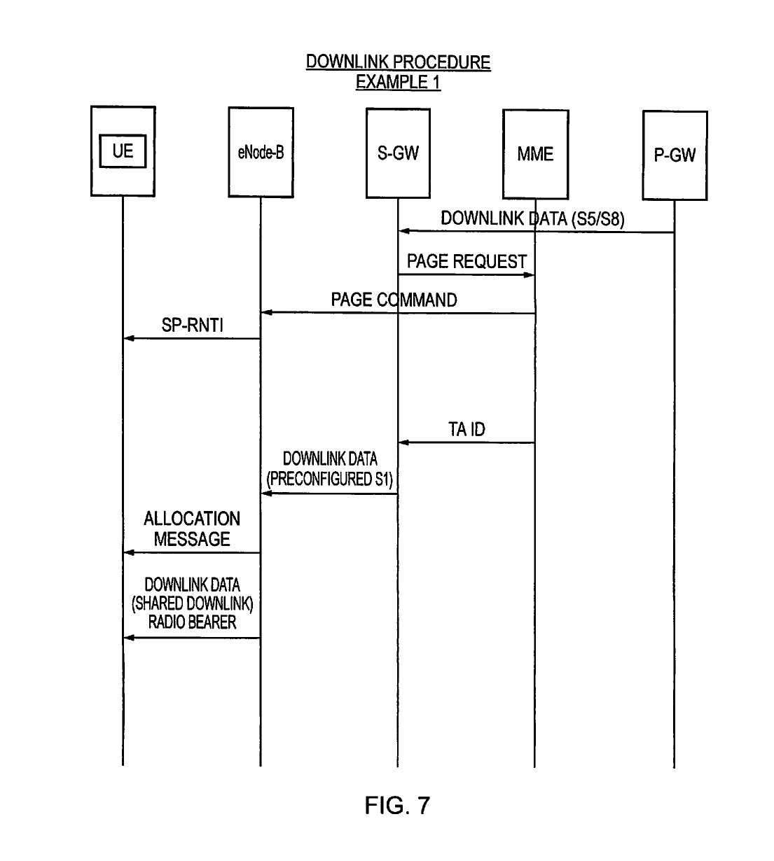

FIG. 7 provides a schematic diagram illustrating a downlink data transmission procedure in accordance with examples of the present technique. As shown in FIG. 7, when the S-GW receives from the P-GW downlink small packet data to transmit to a recipient mobile communication device, the S-GW sends a paging request to the MME.

The paging request includes an indication of the UESCID which identifies the recipient mobile communication device. As explained above, when a mobile communication device initially registers with the network, the MME allocates the UESCIDs and tracks the location of the mobile communication devices. When the MME receives the paging request from the S-GW, the MME determines the tracking area/tracking areas in which the recipient mobile communication device is located. The MME then sends a paging command to all the eNBs within the identified tracking area. Each of the eNBs then transmits a small packet data paging message. The small packet paging message includes a Small Packet RNTI (SP-RNTI) that indicates to all mobile communication devices that have received it that there is pending downlink small packet data. In some examples of the present technique the SP-RNTI may be predefined in a standard and thus the protocol stack of each mobile communication device will be adapted to recognise the SP-RNTI without any further intervention from the network. In other examples, the SP-RNTI will be broadcast on the Broadcast Control Channel (BCCH) in each cell.

On receipt of the small packet paging message including the SP-RNTI, each mobile communication device begins monitoring the physical downlink control channel (PDCCH) for shared channel downlink resource allocation messages transmitted from the eNB. To communicate this allocation, a Shared Radio Network Temporary Identifier (S-RNTI) is defined. The format of the S-RNTI can be pre-defined by standard or signalled by the system (e.g. on the BCCH) S-RNTI is defined The shared channel downlink resource allocation message is sent using the S-RNTI and indicates which PRBs on the PDSCH have been allocated for small packet data i.e. on which PRBs downlink small packet data transported on the downlink shared radio bearer will be transmitted. Upon receipt of a shared channel downlink resource allocation message, each mobile communication device then begins monitoring the PRBs indicated in the allocation message for downlink small packet data.

Meanwhile, in the network the MME sends a TA ID message to the S-GW indicating the tracking area/tracking areas in which the mobile communication device is located. After receiving the TA ID message, the S-GW then forwards the small packet data to each eNB in the tracking area identified in the TA ID message using the preconfigured downlink S1 bearer. The small packet data is then transmitted by each eNB on the shared downlink radio bearer and received by all of the mobile communication devices in the tracking area.

Each mobile communication device that receives the downlink small packet data decodes the received downlink small packet up to the MAC Layer of its downlink protocol stack. When the downlink small packet data is decoded up to this layer, the UESCID associated with intended recipient mobile communication device is revealed. If the UESCID does not correspond to the mobile communication device, the data is discarded at the MAC layer. However, if the UESCID matches the UESCID allocated to the mobile communication device during registration, the MAC layer passes the small packet data up to the higher layers for further processing.

### Shared Downlink Bearer

### Example 2

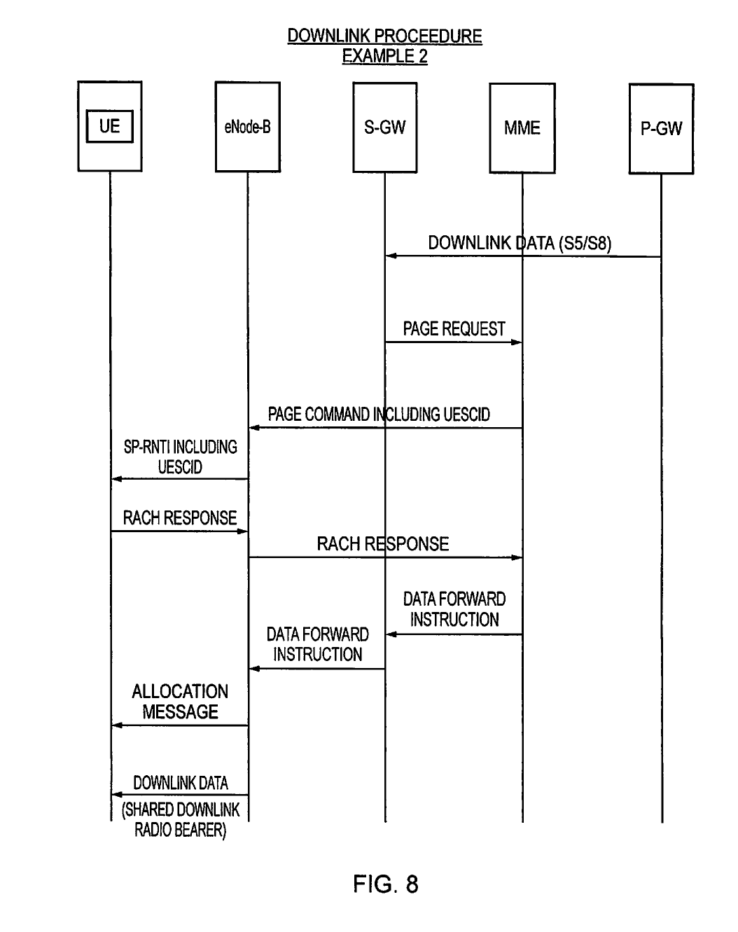

In contrast to conventional LTE downlink data transmission in which each mobile communication device is allocated a dedicated downlink radio bearer, in Example 1 of the shared downlink bearer, all downlink small packet data transmitted within a cell is received and decoded by each mobile communication device (at least to the MAC layer). This is advantageous as it is simple to implement. However, a tracking area typically includes several tens of eNBs, therefore the total number of mobile communication devices in a given tracking area could be quite high, possible exceeding several hundred mobile communication devices. Accordingly, even if each individual mobile communication device only received small packet data on a relatively infrequently, an individual mobile communication device may nevertheless be required to power up to receive and decode downlink data at very frequent intervals. This could lead to excessive power consumption by each mobile communication device. A second example is described with reference to FIG. 8 in which only the mobile communication devices in the cell within which the mobile communication device that is the intended recipient of the downlink small packet data need receive and decode the downlink small packet data.

FIG. 8 provides a schematic diagram illustrating a downlink data transmission procedure in accordance with another example of the present technique in which the number of mobile communication devices that receive the downlink small packet data can be reduced.

In this example, when the MME sends the paging command to each of the eNBs in the relevant tracking area, the paging command includes the UESCID of the recipient mobile communication device. When each eNB transmits the small packet data paging message, the paging message is adapted to also include an indication of the UESCID. If a mobile communication device receives small packet data paging message that includes the UESCID that it was allocated on registration, it transmits a message, for example a dummy/blank message, on the RACH. The dummy/blank message is received by the eNB which identifies the message as a short packet data messages and forwards it to the S-GW on the pre-configured S1 bearer.

After the eNB in question (or the MME) has indicated to the S-GW that it received the dummy/blank message the S-GW then forwards the downlink short packet data to the eNB from which the dummy/blank message originated. The eNB then transmits the downlink short packet data on the shared downlink radio bearer on the allocated resources of the PDSCH. This is received by all the mobile communication devices in the cell served by the eNB. Each mobile communication device then decodes the downlink small packet data to the MAC layer as described above and discards it unless the decoded UESCID matches that allocated to the mobile communication device at registration. As will be understood, in this alternative example, only mobile communication devices sharing the same cell as the recipient mobile communication device will receive and decode the downlink small packet data.

In some scenarios a legacy paging mechanism can be used when it is necessary to decode the UESCID on the shared downlink channels. The mobile communication device can send a modified NAS message to indicate that it has powered up to receive the small packet data. However, this mechanism may be less efficient from a power consumption point of view.

### Security and Mobility Procedures

As explained above, downlink small packet data is received and decoded at least up to the MAC layer by multiple mobile communication devices in addition with the intended recipient mobile communication device. In order to ensure data confidentiality data sent to the mobile communication devices in downlink is ciphered. Ciphering can be performed either by the S-GW or eNB.

During the registration procedure (as shown for example in FIG. 4) the mobile communication device performs standard registration procedures which in some examples includes configuring security keys used to decrypt downlink small packet data and security keys used to encrypt uplink small packet data.

If downlink ciphering is performed by the S-GW, a mobile communication device specific downlink encryption key can be used that prevents mobile communication devices that are not the intended recipient of the downlink data decrypting the downlink data. The S-GW receives information indicating the keys to use by the entity which allocated them. In some examples mobile communication device specific keys can be assigned by the MME in the attach message sent during the registration procedure discussed above. In other examples the keys can be derived from the NAS context. In this case they do not need to be signalled in the attach procedure. If the mobile communication device moves to a tracking area served by a new MME, the mobile communication device specific keys is changed. For example, when a Tracking Area Update (TAU) procedure is invoked and the MME is relocated, the mobile communication device may be assigned new encryption keys and a new identifier used for the shared bearers.

If downlink ciphering is performed by the eNB “global” downlink encryption keys would be used (i.e. a key common to all mobile communication devices in a cell). The global downlink encryption key is sent to each mobile communication device in the attach message transmitted during the registration procedure and are updated when the mobile communication device changes its serving MME. In the case where the ciphering is performed by the eNB each registered mobile communication device can receive and completely decode the downlink small packet data transmitted within a cell. Accordingly, in order to improve data confidentiality between registered users which are configured to use the pre-configured shared bearers, additional security procedures are applied at the Application layer. In some examples this is implemented by an application hosted on an application server and an application hosted on the mobile communication device thus allowing end-to-end encryption. Encryption keys can be negotiated/exchanged by application layer signalling and used thereafter, using for example public-key cryptography.

Uplink small packet data transmitted is ciphered by the mobile communication device. In common with the downlink security, mobile communication device specific uplink keys can be used when the S-GW decrypts the mobile communication device's data. Alternatively shared uplink keys can be used. However, as with the global uplink keys, additional Application layer security is applied to ensure data confidentiality between registered users.

In conventional LTE systems, when a mobile communication device is in the CONNECTED state, the network controls handovers between cells based on measurements made at the mobile communication device. This enables a mobile communication device to continue transmitting and receiving data when changing location within the network in a seamless fashion that is transparent to the user.

In accordance with examples of the present technique, the LTE cell re-selection procedure is adapted to manage mobility between cells and the location update procedure is used to manage mobility between tracking areas. The MME manages mobility of devices in the IDLE state. When the mobile communication device moves to a tracking area requiring a new S-GW and MME to be used a context enabling the mobile communication device to use pre-configured shared bearers as described above are communicated to the new S-GW and MME. Some parameters stored in the context are re-allocated such as the UESCID. The re-allocated UESCID is communicated by the MME to the SG-W and the mobile communication device. Other parameters can be kept unchanged but network entities such as the S-GW and the MME are informed about these parameters (for example, the new S-GW mobile communication device may be informed about the encryption keys currently being used by a mobile communication device).

If the mobile communication device is in the CONNECTED state, mobility can be provided by legacy means. In the connected state, legacy techniques can also be employed to transmit and receive short packet data.

Differentiating Small Packet Data from Regular Data

Typically it may be desirable for a network to be capable of communicating data in accordance with the conventional techniques and in accordance with the shared bearer techniques described above. Accordingly, it is necessary to provide means to determine if packet data should be treated as normal data and transmitted using conventional bearers or if packet data should be treated as small packet data and transmitted using the shared bearer techniques described above.

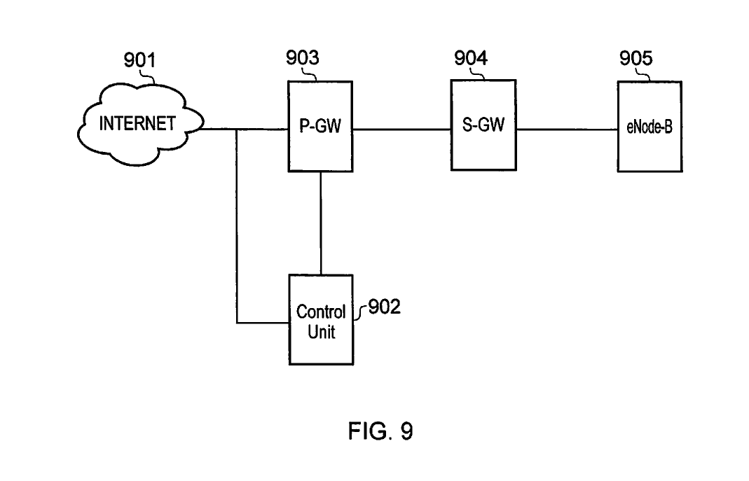

FIG. 9 provides a schematic diagram illustrating an arrangement in the network for determining if downlink data should be communicated conventionally or using the shared bearer techniques described above. Downlink packet data arrives from an external network at the P-GW 903. The P-GW 903 is connected to a control unit 902 which monitors all incoming downlink packet data. If the control unit determines that the downlink data is small packet data it is forwarded on from the P-GW 903 to the S-GW 904 and onwards to the mobile communication device via the eNB 905 using the shared bearer techniques described above. On the other hand, if the data is determined to be regular data, it is forwarded to the S-GW 904 and onwards to the mobile communication device using conventional bearer techniques.

As will be understood, in other examples the S-GW 904, rather than the P-GW 903 may be arranged to detect whether or not the downlink data is small packet data. In this case the control unit 902 is connected to the S-GW 904 and the S5/S8 bearers between the P-GW and the S-GW are common for small packet data and conventional data. In other examples, different APNs can be used for downlink small packet data and downlink conventional data. In this way, the small packet data and the conventional data is implicitly separated.

The control unit 902 can use any suitable process to determine whether incoming downlink data should be treated as small packet data such as packet inspection, or the identification of a small packet data flag or header inserted in downlink small packet data.

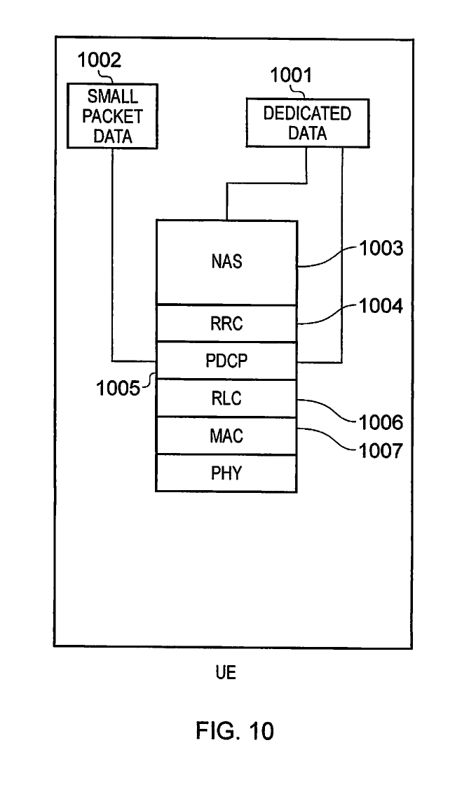

FIG. 10 provides a schematic diagram showing the uplink protocol stack of a mobile communication device for determining if uplink data should be communicated conventionally or using the shared bearer techniques described above. The mobile communication device includes a dedicated (i.e. conventional) data transmission application 1001 for transmitting uplink data in accordance with conventional techniques. Examples of this include the transmission of conventional voice data in which dedicated bearers are established between the mobile communication device and the network.

The mobile communication device also includes a small packet data application 1002 which is arranged to send small quantities of data. In some examples the small packet data application 1002 may be a small packet data application arranged to periodically transmit small quantities of data (for example a few bytes) to an external MTC application server.

The protocol stack includes a Non Access Stratum (NAS) layer 1003 which is arranged to control aspects of the mobile communication device not related to radio access. As is known in the art, this includes management of conventional bearers, authentication, paging, mobility handling and so on.

The protocol stack also includes a Radio Resource Control (RRC) layer 1004; a Packet Data Control Protocol (PDCP) layer (1005); a Radio Link Control (RLC) layer (1006); a Media Access Control (MAC) layer 1007 and a physical (PHY) layer 1008. The functions of these layers are well known in the art and therefore will not be reviewed in detail. Generally speaking the RRC layer 1004, the PDCP layer 1005, the RLC layer 1006 and the MAC layer 1007 combine to provide control of the radio access interface between the mobile communication device and the eNB for example by managing radio bearer control, IP header compression, ciphering, retransmission handling and so on. Generally these layers can be referred to as the Access Stratum (AS).

As can be seen from FIG. 10, uplink data from the dedicated data application triggers the NAS layer to establish a communication bearer with the network (for the mobile communication device when in the IDLE state) and take suitable steps to instantiate the protocol layers.

However, small packet data sent from the small packet data application can bypass the NAS layer 1003 and be sent directly to the AS layers using the pre-configured bearer parameters thus also avoiding the need to use the RRC protocol to establish the bearers and their parameters. Since the protocol stacks are already instantiated using the pre-configured parameters, data can be sent to the PDCP Service access Point (SAP) with the request to transmit data. This is because, as set out above, in accordance with examples of the present technique, the bearers required to send uplink data are pre-configured and there is therefore no need to establish any communication bearers with the network.

### Quality of Service Considerations

In some examples the UESCID can be used to determine the quality of service allocated to specific mobile communication terminals or specific services running on a mobile terminal for uplink data transmission.

In some examples the pre-configured bearers described above are provided with the same quality of service (i.e. the same QOS parameters are associated with each pre-configured bearer). On the other hand, in other examples the pre-configured bearers may be associated with differing qualities of service (i.e. differing QOS parameters). In order to achieve this the UESCID allocated to the mobile communication device by the network is associated with certain predefined QOS parameters. More specifically, for small uplink packet data, the eNB determines which bearer to use based on the UESCID. The QoS parameters can be encoded in the in the UESCID enabling the eNB to map the traffic onto the bearers appropriately. The eNB can also use the QOS parameters encoded in the UESCID information to prioritise radio resource requests (RACH requests).

The S-GW based on the type and QoS of the S5/S8 bearer can use an appropriate mobile communication device identifier (or signal in another parameter) and map mobile communication device's data onto the pre-configured bearer with the desired QoS properties.

### Small Packet Data Transmission Using NAS Messages

In the previously described examples, uplink small packet is transmitted using the uplink pre-configured shared bearer described with respect to FIG. 6 and on the downlink using the downlink pre-configured shared bearer described using the pre-configured shared bearers. In these examples, as described above, in order to ensure that the transmitted small packet data is secure, additional encryption mechanisms are put in place such as uplink and downlink ciphering using suitably defined encryption keys. Whilst encrypting small packet data improves the security with which the downlink small packet data is communicated by reducing the likelihood that the small packet data can be transmitted or received by an unauthorised user, it nevertheless necessitates additional security mechanisms be implemented within the network and the mobile communication terminal.

However, in some examples of the present invention, existing transmission mechanisms can be adapted for the transmission small packet data so that security functionality that is already provided for the transmission of conventional data can be re-used. In one example, uplink small packet data is transmitted by inserting the small packet data into modified NAS messages.

For uplink data transmission, the modified NAS messages are transmitted using the uplink pre-configured shared bearers using the UESCID as described above. The modified NAS messages are transmitted as user-plane (u-plane) NAS messages but include a c-plane identifier that indicates that they are to be treated within the network as control-plane (c-plane) data. When the modified c-plane NAS message is received by the eNB, based on the UESCID and the c-plane identifier, the eNB routes the small packet data to the MME which allocated the mobile communication device its UESCID using the existing interface between the eNB and the MME. The MME then forwards the small packet data to the S-GW in accordance with normal c-plane data routing i.e. using the GTP-C protocol. On receipt of the data from the MME, the S-GW can either forward the data to the P-GW using the c-plane routing or the S-GW de-capsulates the data from the GTP-C message and forwards it as u-plane data over the S5/S8 bearers to the PDN-GW.

For downlink data transmission, small packet data is forwarded by the P-GW to the S-GW in accordance with u-plane data routing. The S-GW then forwards the downlink small packet data to the MME which encapsulated it as a modified downlink NAS message and performs legacy NAS encryption. In other examples the P-GW can forward the data the MME using c-plane data routing (i.e. employing the GTP-C protocol via the S-GW). The MME triggers paging and delivers the modified NAS message over the S1-MME interface to all the eNBs which are in the tracking area or tracking areas where the mobile communication device is currently registered or alternatively just the eNB which forwards the mobile communication device's paging response.

Various modifications may be made to the embodiments herein before described. For example embodiments of the present invention have been described with reference to an implementation which uses a mobile radio network operating in accordance with the 3GPP Long Term Evolution (LTE) standard. However it will be understood that the principles of the present invention can be implemented using any suitable radio telecommunications technology and using any suitable network architecture in which shared communication bearers could be advantageously employed for example GSM, GPRS, W-CDMA (UMTS), CDMA2000, and other mobile communication standards.

1-40. (canceled)

41. A wireless network comprising:
a network device configured to establish one or more pre-configured shared communication bearers between infrastructure equipment and an eNode-B, each of the one or more pre-configured shared communication bearers communicate data to a mobile device, via a shared radio bearer, in accordance with predetermined operating parameters;
wherein each of the one or more pre-configured shared communication bearers have a pre-defined quality of service; and
wherein the shared radio bearer is pre-configured and allocated the predetermined operating parameters needed for the mobile device to communicate via the shared radio bearer before the mobile device has information to be communicated via the one or more pre-configured shared communication bearers.

42. The wireless network of claim 41, wherein the mobile device is allocated a unique identifier during an initial registration procedure, and the mobile device is configured to use the unique identifier to send uplink data on the shared radio bearer or the one or more pre-configured shared communication bearers.

43. The wireless network of claim 41, further comprising:
the mobile device is configured, prior to the mobile device sending uplink data, to send a random access request on a random access channel requesting access to the shared radio bearer, the random access request including a unique identifier.

44. The wireless network of claim 41, further comprising:
the infrastructure equipment is configured to page the mobile device with a paging message including a shared radio network temporary identifier (RNTI) to indicate that there is pending downlink data; and
wherein the mobile device is configured to monitor a physical control channel for allocation information indicating resources on another shared radio bearer on which the downlink data will be sent.

45. The wireless network of claim 41, wherein downlink data is sent to the mobile device on another shared radio bearer, the downlink data including a unique identifier allocated to an intended recipient mobile device, and the mobile device is configured to process the downlink data to determine if the unique identifier included in the downlink data corresponds to an allocated unique identifier of the mobile device during a registration procedure.

46. The wireless network of claim 41, further comprising:
the mobile device is configured to discard downlink data if a unique identifier included in the downlink data does not correspond to an allocated unique identifier of the mobile device; and
the mobile device is configured to retain the downlink data for further processing if the unique identifier included in the downlink data does correspond to an allocated unique identifier of the mobile device.

47. The wireless network of claim 41, further comprising:
the network device is further configured to provide a paging message that includes a unique identifier allocated to an intended recipient mobile device having pending downlink data;
wherein if the unique identifier allocated to the intended recipient mobile device corresponds to an identifier allocated to the mobile device during a registration procedure, the mobile device is configured to send a response message to the eNode-B that is forwarded to the infrastructure equipment; and
wherein the infrastructure equipment is configured to determine from the response message that the intended recipient mobile device is located in a coverage area of the eNode-B and forward the pending downlink data to the eNode-B.

48. A wireless network of claim 41, wherein downlink data is sent to the mobile device and uplink data is sent from the mobile device without the mobile device transitioning to a connected state in which communication bearers dedicated to the mobile device are established.

49. A mobile device comprising:
a processor configured to send data on a pre-configured shared radio bearer to an eNode-B in a wireless network, wherein the pre-configured shared radio bearer is associated with predetermined operating parameters for providing a pre-defined quality of service; and
wherein the pre-configured shared radio bearer is allocated the predetermined operating parameters that are required for the mobile device to communicate via the pre-configured shared radio bearer before the mobile device has the data to be communicated via a pre-configured shared communication bearer associated with the eNode-B.

50. The mobile device of claim 49, further comprising:
the mobile device is configured to receive a unique identifier allocated by the wireless network during an initial registration procedure and the mobile device is configured to use the unique identifier to send uplink data on the pre-configured shared radio bearer.

51. The mobile device of claim 49, further comprising:
the mobile device is configured, prior to the mobile device sending uplink data, to send a random access request on a random access channel requesting access to the pre-configured shared radio bearer, the random access request including a unique identifier.

52. The mobile device of claim 49, further comprising:
the mobile device is configured to receive a paging message including a shared radio network temporary identifier (RNTI) to indicate that there is pending downlink data; and
the mobile device is configured to monitor a physical control channel on which is sent allocation information indicating resources on another pre-configured shared radio bearer on which the downlink data will be sent.

53. The mobile device of claim 49, further comprising:
the mobile device is configured to receive downlink data on another pre-configured shared radio bearer, the downlink data including a unique identifier allocated to an intended recipient mobile device; and
the mobile device is configured to process the downlink data to determine if the unique identifier included in the downlink data corresponds to an identifier allocated to the mobile device during a registration procedure.

54. The mobile device of claim 49, further comprising:
the mobile device is configured to receive a paging message that includes a unique identifier allocated to an intended recipient mobile device having pending downlink data;
wherein if the unique identifier allocated to the intended recipient mobile device corresponds to an identifier allocated to the mobile device during a registration procedure, the mobile device is configured to send a response message to the eNode-B that is forwarded to a component in the wireless network; and
wherein the response message is used to determine that the intended recipient mobile device is located in a coverage area of the eNode-B.

55. The mobile device of claim 49, wherein the mobile device is configured to receive downlink data and uplink data without the mobile device transitioning to a connected state in which communication bearers dedicated to the mobile device are established.
